(19) United States
(12) Patent Application Publication
(10) Pub. No.: US 2012/0281958 A1
(43) Pub. Date: Nov. 8, 2012

(54) RE-ENTERABLE CABLING SYSTEM FOR IN-BUILDING APPLICATIONS

(75) Inventors: Kurt H. Petersen, Austin, TX (US); Stephen Paul LeBlanc, Austin, TX (US); Curtis L. Shoemaker, Round Rock, TX (US)

(73) Assignee: 3M Innovative Properties Company

(21) Appl. No.: 13/454,545

(22) Filed: Apr. 24, 2012

Related U.S. Application Data
(60) Provisional application No. 61/482,840, filed on May 5, 2011.

(51) Int. Cl. H01B 7/40; G02B 6/00

(52) U.S. Cl. 385/135; 174/135

(57) ABSTRACT

According to an exemplary aspect of the present invention, a re-enterable cabling structure includes a continuous flexible longitudinal body having a planar base portion and a cover portion and an intermediate portion disposed between the base portion and the cover portion. The intermediate portion is connected to the base portion by the first flexible portion and the cover portion is attached to the intermediate portion by a second flexible portion such that when the cabling structure is folded, the intermediate portion is disposed between the base portion and the cover portion. The base portion includes one or more open cable tracks formed in the base portion to accommodate the insertion of cables.

### CROSS-REFERENCE TO RELATED APPLICATION

This application claims the benefit of U.S. Provisional Patent Application No. 61/482840, filed May 5, 2011, the disclosure of which is incorporated by reference herein in its entirety.

### BACKGROUND OF THE INVENTION

1. Field of the Invention

The present invention is directed to re-enterable cabling for in-building wireless (IBW) horizontal cabling applications.

2. Background

More than half of all mobile communications originate from inside buildings. With the development of 3G and 4G smart phones and other data intensive mobile devices, increasing demand is being placed on wireless and wired infrastructure within buildings such as office buildings, schools, hospitals, and residential units. Better wired and wireless communication coverage is needed to provide the desired bandwidth to an increasing number of customers. However, the labor to install these enhanced wired and wireless systems in existing buildings can be costly, so a low cost and easy to install structured cabling solution to enhance wired and/or wireless coverage within a building is needed.

In-Building Wireless (IBW) Distributed Antenna Systems (DASs) are utilized to improve wireless coverage within buildings and related structures. Conventional DASs use strategically placed antennas or leaky coaxial cable (leaky coax) throughout a building to accommodate radio frequency (RF) signals in the 300 MHz to 6 GHz frequency range. Conventional RF technologies include TDMA, CDMA, WCDMA, GSM, UMTS, PCS/cellular, iDEN, WiFi, and many others. Additional wireless signals which use an in-building wireless network can also include telemetry, WiFi, public safety signals.

Conventional wired communications systems include enterprise grade Passive Optical Networks (PONs) and Ethernet over twisted pairs or optical fibers. Wired cabling can also be used for remote powering of optical fiber fed wireless access points and remote radios for the in building wireless system.

Outside the United States, carriers are required by law in some countries to extend wireless coverage inside buildings. In the United States, bandwidth demands and safety concerns will drive IBW applications, particularly as the world moves to current 4G architectures and beyond.

There are a number of known network architectures for distributing wireless communications inside a building. These architectures include choices of passive, active and hybrid systems. Active architectures generally include manipulated RF signals carried over fiber optic cables to remote electronic devices which reconstitute the electrical signal and transmit/receive the signal. Passive architectures include components to radiate and receive signals, usually a coaxial cable attached to discrete antennas or through a punctured shield leaky coax network. Hybrid architectures include native RF signal carried optically to active signal distribution points which then feed multiple coaxial cables terminating in multiple transmit/receive antennas. Specific examples include analog/amplified RF, RoF (Radio over Fiber, also known as RFoG, or RF over glass), fiber backhaul to pico and femto cells, and RoF vertical or riser distribution with an extensive passive coaxial distribution from a remote unit to the rest of the horizontal cabling (within a floor, for example). These conventional architectures can have limitations in terms of electronic complexity and expense, inability to easily add services, inability to support all combinations of services, distance limitations, or cumbersome installation requirements.

Conventional cabling for IBW applications includes RADIAFLEX™ cabling available from RFS (www.rfsworld.com), standard ½ inch coax for horizontal cabling, ⅞ inch coax for riser cabling, as well as, standard optical fiber cabling for riser and horizontal distribution. Physical and aesthetic challenges exist in providing IBW cabling for different wireless network architectures, especially in older buildings and structures. These challenges include gaining building access, limited distribution space in riser closets, and space for cable routing and management.

### SUMMARY

According to an exemplary aspect of the present invention, a re-enterable cabling structure includes a continuous flexible longitudinal body having a planar base portion and a cover portion and an intermediate portion disposed between the base portion and the cover portion. The intermediate portion is connected to the base portion by the first flexible portion and the cover portion is attached to the intermediate portion by a second flexible portion such that when the cabling structure is folded, the intermediate portion is disposed between the base portion and the cover portion. The base portion includes one or more open cable tracks formed in the base portion to accommodate the insertion of cables.

Advantageously, the cable tracks can be populated with any mix and match combination of small cables including optical fibers, insulated copper wires, ribbon cables, twinax cables and small diameter coax cables. Thus, the one or more cable tracks in cabling structure can accommodate a first type of cable while other cable tracks can accommodate a second type of cable.

In one exemplary use, the re-enterable cabling structure can be used as part of an in-building wireless system. In this system, the re-enterable cabling structure, as described above, can be used as horizontal cabling between interface boxes, access boxes, distribution boxes and remote antennas within the building.

In an alternative aspect of the present invention, a cabling system for in-building wireless applications is disclosed. The cabling system includes a re-enterable cabling structure to distribute signals from an antenna to an interface box. The cabling structure includes a continuous flexible longitudinal body having a planar base portion and a cover portion attached to the base portion by a first flexible portion. The base portion includes one or more open cable tracks formed in the base portion to accommodate the insertion of cables. A securing mechanism secures the base portion to the cover portion when the cover portion is folded over the base portion. The exemplary cabling system can be used with RoF DAS and split radio, software defined radio, pico cell, and femto cell in-building wireless networks.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIGS. 1A and 1B are two isometric views of a re-enterable cabling structure in accordance with an aspect of the present invention;

FIGS. 2A-2B are two alternative isometric views of exemplary re-enterable cabling structures in accordance with an aspect of the present invention;

FIG. 3 is an isometric view of a re-enterable cabling structure in accordance with an aspect of the present invention; and

FIGS. 4A-4C shows the assembly of the re-enterable cabling structure of FIG. 3;

FIG. 5 is an isometric view of as alternative re-enterable cabling structure in accordance with an aspect of the present invention; and

FIG. 6 shows an exemplary use of a re-enterable cabling structure in accordance with an aspect of the present invention;

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a re-enterable cabling system comprising a folded duct for in-building wireless (IBW) and wireline applications. The inventive cabling solutions described herein provide multiple signal pathways for coaxial (coax) cables, optical fibers, and power distribution cabling. The re-enterable cabling system is designed with a low impact profile for better aesthetics and can provide for multiple channels of RF/cellular or data traffic to be distributed within a building or premises location such as a single family home, multi-dwelling unit or apartment building, an office building, a hospital, or a university, for example.

These multiple signal pathways can be dedicated to different carriers, with each carrier needing wireless distribution within a building, or to providing different services such as data transmission. These multiple signal pathways can also be dedicated to routing signals to different locations within a building. The inventive cabling system may be used above the ceiling or below the ceiling. Thus, the re-enterable cabling structure enables flexible network design and optimization for a given indoor environment.

The cabling structure can be designed to accommodate most small forms of optical fiber or electrical cables. For example, the cable tracks within the cabling structure may be sized to accommodate one of a copper ribbon cable, a fiber ribbon cable a twin ax cable, a micro-coax cable, a twisted pair cable such as a CAT 5e cable or a CAT 6 cable, a coated wire, an optical fiber drop cable or a 900 micron coated optical fiber.

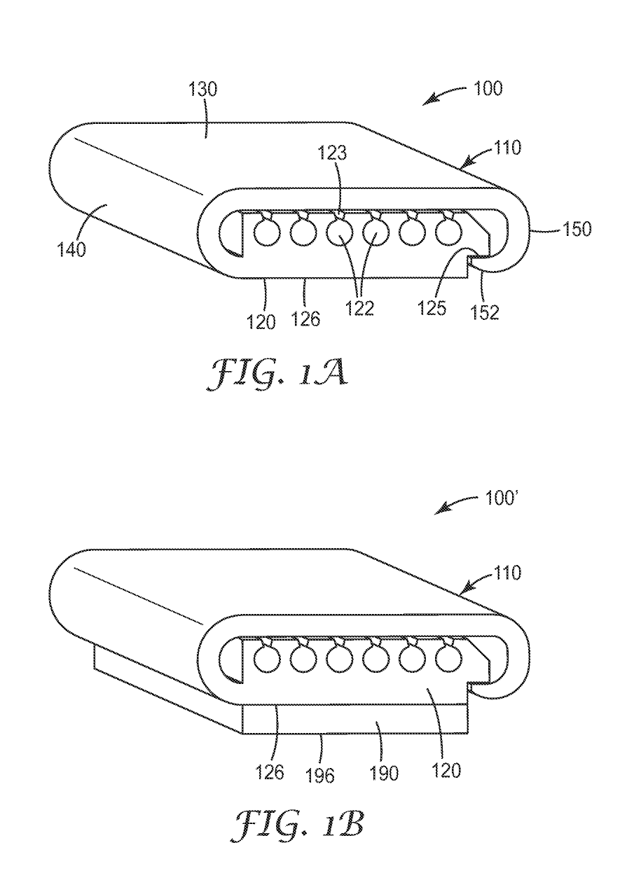

In a first aspect of the invention shown in FIG. 1A, re-enterable cabling structure 100 accommodates multiple signal pathways for a structured cabling system that can distribute wireless and wireline signals within buildings. Re-enterable cabling structure 100 can be a duct or auxiliary sheath having a longitudinal body 110. The longitudinal body includes a planar base portion 120 and a cover portion 130 attached to the base portion by a first flexible portion 140 such that the cover portion can be folded over the top of the base portion.

In one aspect, the longitudinal body 110 is a continuous structure formed from a polymeric material such as polyvinyl chloride (PVC), making it flexible, flame retardant and robust. In one aspect, longitudinal body 110 can comprise an exemplary material such as a polyurethane elastomer, e.g., Elastollan 1185A10FHF (available from BASF, Florham Park, N.J.). As such, longitudinal body 110 can be guided and bent around corners and other structures without cracking or splitting. The longitudinal body 110 can be continuously formed flat using a conventional extrusion process and folded to yield the re-enterable cable structure described herein. The longitudinal body 110 can have a relatively compact shape, with a lateral dimension from about 0.4 inches to about 3 inches, and a height of less than about 0.1 inch to about 0.5 inches in a flat unfolded configuration and a lateral dimension from about 0.2 inches to about 1.5 inches, and a height of less than about 0.2 inch to about 1.0 inches in its folded or assembled configuration.

Base portion 120 can include one or more open cable tracks 122 formed in the base portion to hold communication or power cables. The cable tracks may be sized to accommodate one of a copper ribbon cable, a fiber ribbon cable a twin ax cable, a microcoax cable, a twisted pair cable such as CAT 5e or CAT 6 cable, a coated wire, an optical fiber drop cable or a 900 micron coated optical fiber. In one exemplary aspect, the cable tracks can have a C-shaped cross section to accommodate round cables or wires. For example, C-shaped cable tracks can be sized to accept 900 μm tight buffered optical fibers, or insulated copper wires (e.g. AWG 24-18). The cable tracks 122 can be populated with any number of N≦M optical fibers, where N is the number of optical fibers and M is the total number of cable tracks in the cabling structure. Alternatively, the cable tracks can be populated by any number of W≦(M−N) insulated copper wires, where W is the number of insulated copper wires. Thus, the cable tracks can be populated with any mix and match combination of optical fibers and insulated copper wires. Thus, the one or more cable tracks in cabling structure can accommodate a first type of cable while other cable tracks can accommodate a second type of cable.

In an alternative aspect, the cable tracks can have an open elongated slot or channel shaped cross section to accommodate copper or fiber ribbon cables or twinax style cables. In an exemplary aspect, the cable tracks can have a chamfered opening slot 123 to facilitate the guiding of wires and/or cables into each cable track.

Advantageously, the C-shaped cable tracks are designed to hold the cables and/or wires so that they will not fall out of the cable tracks when the cabling structure is opened, even when the cabling structure is mounted on a vertical surface or upside down on a ceiling or other mounting structure.

In an alternative aspect, two adjacent cable tracks in the base portion can be sized to accommodate two different sized communication cables such as a coated copper wire in one cable track and a 900 micron optical fiber in an adjacent cable track.

The re-enterable cabling structure can further include a securing mechanism 150 formed on one end of one of the base and the cover portions to secure the base portion and the cover portion to one another when the cover portion is folded over the base portion. In the exemplary aspect shown in FIG. 1A, the securing mechanism is in the form of a hook or a latch 152 extending from cover portion 130 to engage with a lip 125 formed in the base portion of the longitudinal body. In an alternative aspect, the securing mechanism could include a slot and circular cavity formed on one end of the base that accepts a cylindrical bulb disposed longitudinally on top a wall or projection extending from the cover.

In an exemplary aspect, cabling structure can include an adhesive backing layer attached to a portion of the longitudinal body to mount the cabling structure to a mounting surface. In a preferred aspect, as shown in FIG. 1B, the base portion 120 of the longitudinal body 110 includes a rear surface 126 that can have a generally flat surface shape. The rear surface provides suitable surface area for adhering the cabling structure to a mounting surface, a wall or other surface (e.g., a dry wall, concrete, or other conventional building material) using an adhesive, such as a pressure sensitive adhesive (e.g. transfer adhesive or double-sided tape). For example, in a preferred aspect of the present invention, cabling structure 100′ comprises a pressure sensitive adhesive disposed on all or at least part of rear surface 126 of the base potion 120 of the longitudinal body 110. These types of adhesives do not exhibit macroscopic flow behavior upon application to a mounting surface and thus do not substantially change dimensions upon application to the mounting surface. In this manner, the aesthetic quality of the applied duct is maintained. Alternatively, adhesive backing layer 190 can comprise an epoxy or other structural adhesive.

In one aspect, adhesive backing layer 190 adhered to the longitudinal body 110 of the cabling structure can have a removable liner (not shown) disposed on the exposed adhesive surface 196 until just prior to application to a mounting surface. In use, the liner can be removed and cabling structure can be applied to a mounting surface via adhesive backing layer 190. For example, an adhesive such as a factory applied 3M™ VHB™ Tape 4941F can be utilized as adhesive backing layer 190. In another aspect, adhesive backing layer 190 can be a removable adhesive, such as a stretch release adhesive. By “removable adhesive” it is meant that the cabling structure can be mounted to a mounting surface (preferably, a generally flat surface, although some surface texture and/or curvature are contemplated) so that the longitudinal body remains in its mounted state until acted upon by an installer/user to remove the cabling structure from its mounted position. Even though the duct is removable, the adhesive is suitable for those applications where the user intends for the duct to remain in place for an extended period of time. Suitable removable adhesives are described in more detail in PCT Publ. No. WO 2011/129972, incorporated by reference herein in its entirety.

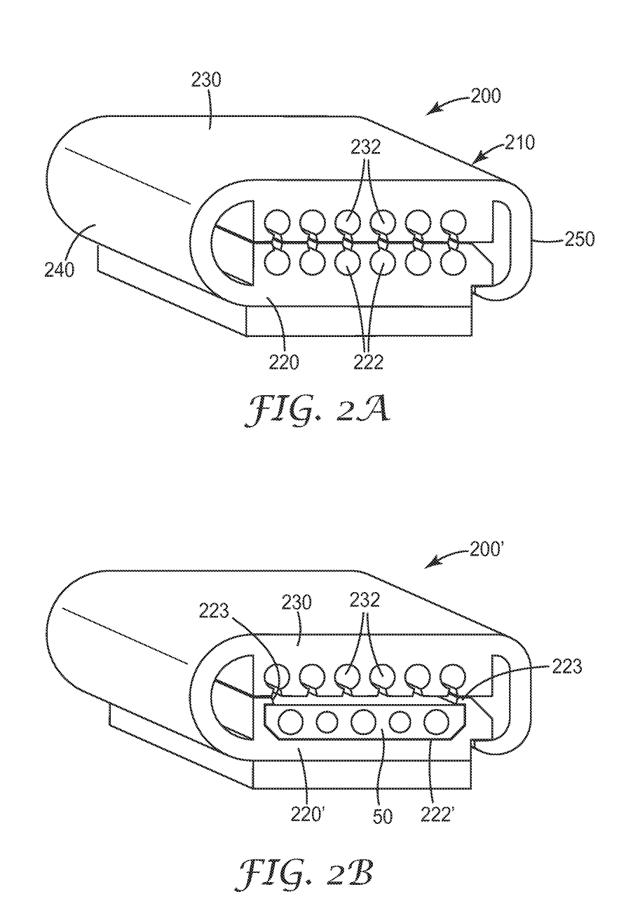

FIG. 2A illustrates a re-enterable cabling structure 200 which can accommodate multiple signal pathways for a structured cabling system that can distribute wireless and wireline signals within buildings. Re-enterable cabling structure 200 has a longitudinal body 210. The longitudinal body includes a planar base portion 220 and a cover portion 230 attached to the base portion by a first flexible portion 240 such that the cover portion can be folded over the top of the base portion.

Base portion 220 includes a plurality of cable tracks 222 formed in the base portion to hold communication or power cables and a second grouping of cable tracks 232 can be formed in the cover portion 230 to accommodate additional communication or power cables. In one exemplary aspect, the cable tracks 222, 232 in the base and cover portion can have the same size to accommodate the same cable type or size. Alternatively, one or more cable tracks in the base portion 220 of the longitudinal body 210 can accommodate a first type (or size) of cable and the second grouping of cable tracks 232 in the cover portion can accommodate a second type or size of cable. Alternatively, the adjacent cable tracks can accommodate different types of cables.

For example, cable structure 200 shown in FIG. 2B has a plurality of C-shaped cable tracks 232 in cover portion 230 and a single wide open channel shaped cable track 222′ formed in base portion 220′ to hold a ribbon cable 50 having multiple signal or power pathways. Cable track 222′ is formed in base portion 220′ with a continuous overhanging lip 223 formed along each longitudinal edge of the open channel shaped cable track. The overhanging lip will retain ribbon cable 50 in the cable track when the cabling structure is in an open or unfolded state even when mounted upside down on a ceiling of a building.

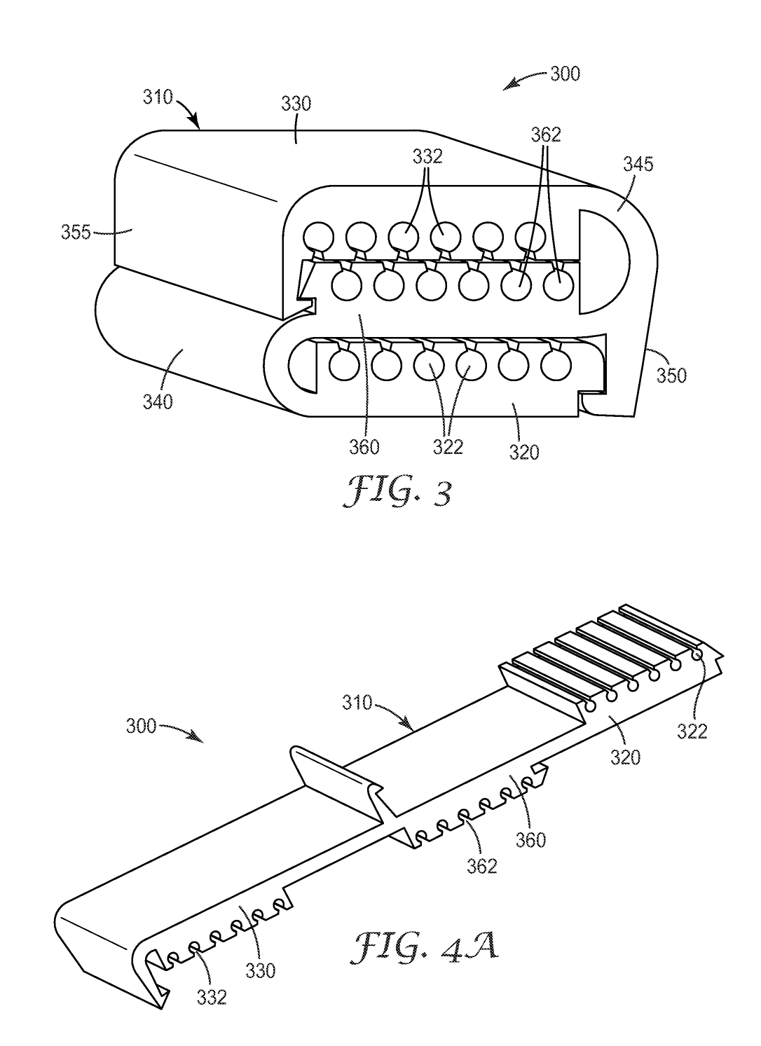

FIG. 3 shows another exemplary embodiment of a cabling structure 300 in accordance with the present invention. Re-enterable cabling structure 300 has a longitudinal body 310. The longitudinal body includes a planar base portion 320, a cover portion 330 and an intermediate portion 360 disposed between the base portion and the cover portion. The intermediate portion is connected to the base portion by the first flexible portion 340 and the cover portion is attached to the intermediate portion by a second flexible portion 345 such that when the cabling structure is folded, the intermediate portion 360 is disposed between the base portion 320 and the cover portion 330.

Cabling structure 300 can have cable tracks in any of the base portion, the cover portion or the intermediate portion. For example, FIG. 3 shows a first grouping of cable tracks 322 in the base portion 320, a second grouping of cable tracks 332 in the cover portion 330 and a third grouping of cable tracks 362 in the intermediate portion 360 of the longitudinal body 310. Each of the groupings of cable tracks may be sized to hold the same type or size of communication cables or wires or may be sized to hold different types or sizes of communication cables or wires from another of the groupings of cable tracks. Additionally, it is contemplated that the cable tracks within a single grouping of cable tracks may be sized to accommodate different types or sizes of communication cables or wires.

Additionally, cabling structure 300 includes a first securing mechanism 350 to secure the base portion 320 and the intermediate portion 330 to one another when the intermediate portion is folded over the base portion and a second securing mechanism 355 secure the intermediate portion 360 and the cover portion 330 to one another when the cover portion is folded over the intermediate portion as shown in FIG. 3. This structure can provide craft separation between feeder lines and drop lines or between different media types such as electrical lines and optical lines by placing one segment of lines between the base portion 320 and the intermediate portion 330 (e.g. the electrical lines/and/or the feeder lines) and a second segment of lines between the intermediate portion 360 and the cover portion 330 (e.g. the fiber lines and or the drop lines).

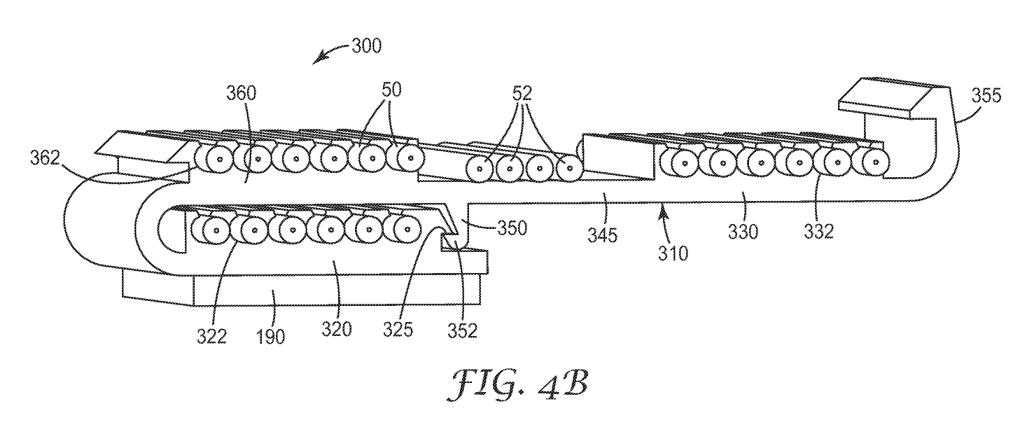

FIGS. 4A-4C shows the assembly of the re-enterable cabling structure of FIG. 3. FIG. 4A shows the longitudinal body in an unfolded or unassembled form. The longitudinal body 310 can be formed by a conventional extrusion process as a flat body, the cables inserted into the cable tracks and folded to form the final re-enterable cabling structure. The cables 50 have been added to all of the cable tracks 322, 332, 362 and additional cables 52 have been laid on flexible portion 345 in FIG. 4B. The intermediate portion 360 has been folded over the base portion 320 and secured in place by a first securing mechanism 350 by engaging the hook 352 on the securing mechanism with a lip 325 formed on the base portion. FIG. 4C shows the assembled re-enterable cabling structure; the cover portion 330 having been folded over the intermediate portion 360 and secured in place by a second securing mechanism 355 by engaging the hook 357 on the securing mechanism with a lip 365 formed on the intermediate portion.

Adhesive backing layer 190 can be laminated to longitudinal body 310 prior to adding the cables to the cable tracks while the longitudinal body is in is unassembled or flat form. Alternatively, the adhesive backing layer 190 can be laminated to the fully assembled re-enterable cabling structure 300 prior to installation on a mounting surface.

In some embodiments, the cabling structures of the current disclosure can be used without an additional adhesive backing layer such as when the cabling structure is mounted above the ceiling or in a wiring conduit or race track.

To access cables within the re-enterable cabling structure, the securing mechanism can be released to expose the cables in the desired section of the cabling structure. Once the required task is complete, the securing mechanism can be re-engaged to enclose the cables within the cabling structure.

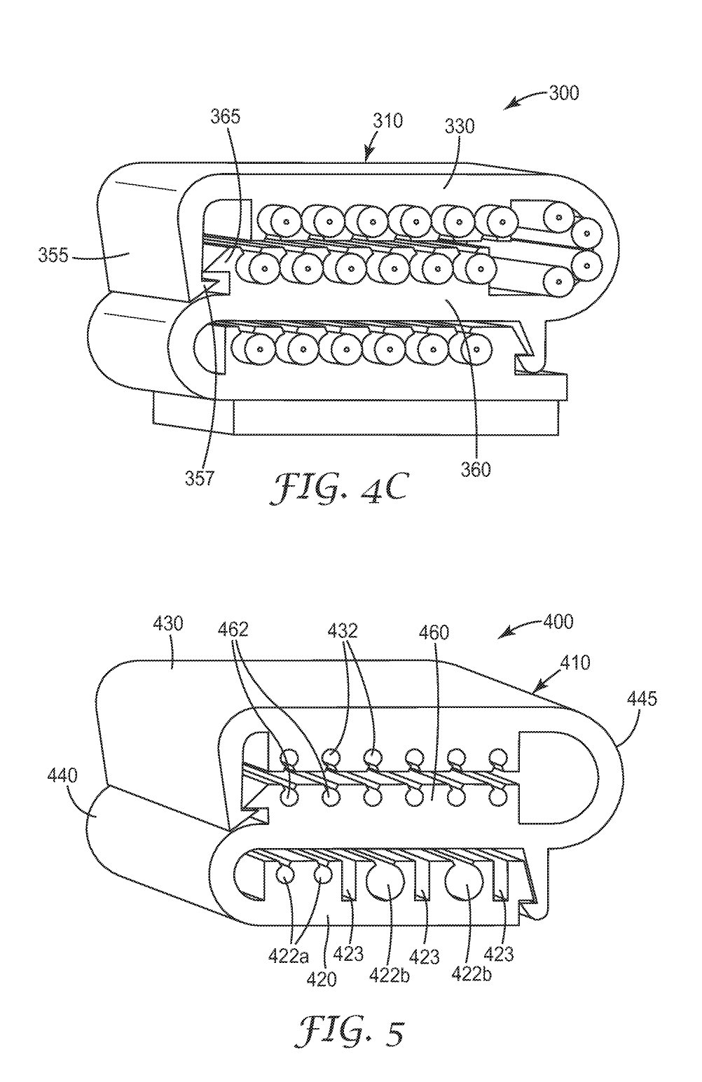

FIG. 5 shows another exemplary embodiment of a cabling structure 400 in accordance with the present invention. Re-enterable cabling structure 400 is similar to the re-enterable cabling structure 300 of FIG. 3. Cabling structure 400 has a longitudinal body 410 that includes a planar base portion 420, a cover portion 430 and an intermediate portion 460 disposed between the base portion and the cover portion. The intermediate portion is connected to the base portion by the first flexible portion 440 and the cover portion is attached to the intermediate portion by a second flexible portion 445 such that when the cabling structure is folded, the intermediate portion 460 is disposed between the base portion 420 and the cover portion 430.

Cabling structure 400 can have cable tracks in any of the base portion, the cover portion or the intermediate portion. In particular, the grouping of cable tracks in the base portion comprises two small cable tracks 422a and two larger cable tracks 422b. The small cable tracks can be designed to hold 900 μm tight buffered optical fibers, or insulated copper wires (e.g. AWG 24-18), while the larger cable tracks can accommodate larger gauge wires, jacketed optical fiber cables or micro-coax cables. Additionally base portion 420 can have a plurality of channels 423 on each side of the larger cable tracks 422b to facilitate insertion and removal of the larger cables into the cable tracks.

FIG. 5 additionally shows a second grouping of cable tracks 432 in the cover portion 430 and a third grouping of cable tracks 462 in the intermediate portion 460 of the longitudinal body 410. Each of the groupings of cable tracks may be sized to hold the same type or size of communication cables or wires or may be sized to hold different types or sizes of communication cables or wires from another of the groupings of cable tracks.

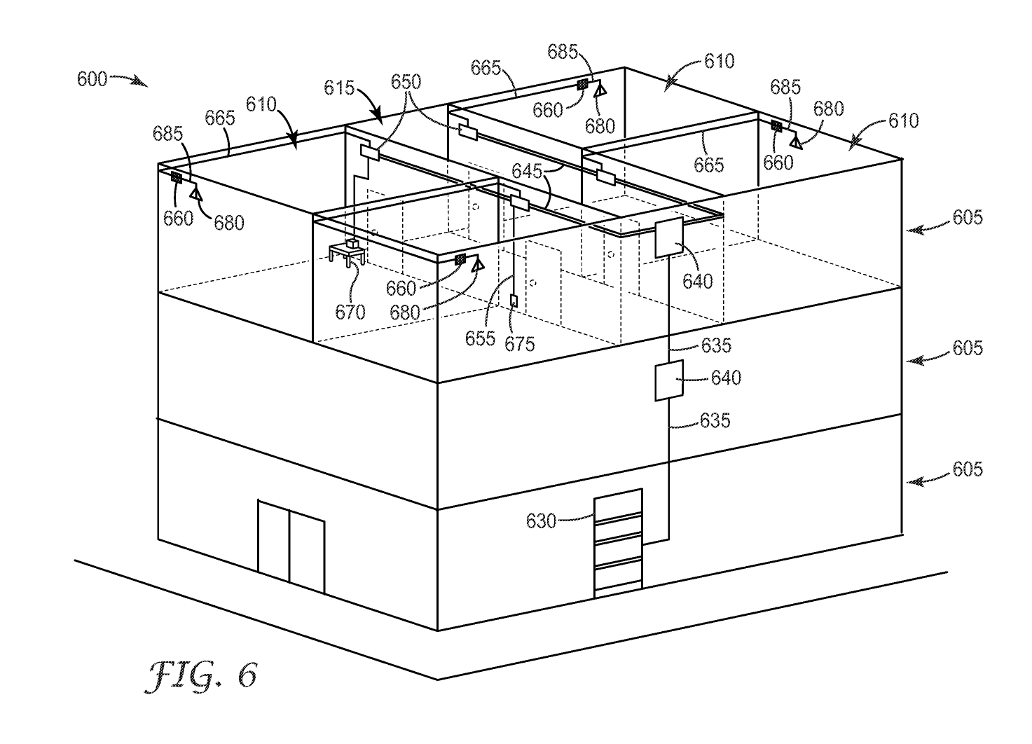

In one exemplary use, the re-enterable cabling structure can be used as part of a converged in-building wireline and wireless system as shown in FIG. 6. In this system, the re-enterable cabling structure, as described above, can be used as horizontal cabling between area junction boxes or distribution boxes located on each floor and the point of entry boxes located at one or more access points 650, such as at or near the entryway of a living unit. Additionally, the re-enterable cabling structure can carry multiple optical fiber plus power cables within each living unit from the point of entry box to a remote radio socket located near each of the distributed antennas.

For example, FIG. 6 shows an exemplary multi-dwelling unit (MDU) 600 having four living units 610 on each floor 605 within the building with two living units located on either side of a central hallway 615.

A feeder cable (not shown) brings wired communications lines to and from building 600 from the traditional communication network and coax feeds bring the RF or wireless signals into the building from nearby wireless towers or base stations. All of the incoming lines (e.g. optical fiber, coax, and traditional copper) are fed into a main distribution facility in the basement or equipment closet of the MDU, which is used to organize the signals coming into the building from external networks to the centralized active chassis equipment for the system. Power mains and backup power is typically configured in this main distribution facility. Additionally, fiber and power cable management which supports the indoor wired and wireless networks both into the building from the outside plant and onto the rest of the indoor network distribution system can be located in the main distribution facility. The main distribution facility can include one or more racks 630 to hold equipment chassis as well as telecommunication cable management modules. Exemplary equipment which can be located on the rack in the main distribution facility can include, for example, a plurality of RF signal sources, an RF conditioning drawer, a DAS hub, a power distribution equipment, and DAS remote management equipment. Exemplary telecommunication cable management modules can include, for example, a fiber distribution hub, a fiber distribution terminal or a patch panel.

Riser cables or trunk cables 635 run from the equipment rack 630 in the main distribution facility to the area junction boxes 640 located on each floor 605 of the MDU 600. The area junction box provides the capability to aggregate horizontal fiber runs and optional power cabling on each floor. At the area junction box, trunk cabling can be broken out into a number of inventive cabling structures containing optical fibers or other communication cables and power cables, described herein. The cabling structures can act as horizontal cabling 645 within the MDU carrying the wired and wireless signals through a variety of interface boxes such as a point of entry box, a access box or an additional distribution box to the antennas. A point of entry box 650 can be located at each living unit to split off power and communication cables to be used within a given living unit 610.

These cables feed remote radio sockets 660 as well as connections to communication equipment 670 inside of each living unit or a wall receptacle 675 to which a piece of communication equipment can be connected by a patchcord (not shown) through point of entry boxes 650. Exemplary communication equipment can include a single family unit optical network terminal (SFU ONT), desktop ONT, or similar device (e.g., a 7342 Indoor Optical Terminal, available from Alcatel-Lucent or a Motorola ONT1120GE Desktop ONT).

The optical fibers and power cables which feed the remote radio socket can be disposed in a second smaller (i.e. lower cable count) re-enterable cabling structure 655 also described herein. Alternatively, the fibers and power cables may be carried in a ducted structure such as that described in U.S. Patent Publication Nos. 2009/0324188 and 2010-0243096, incorporated by reference herein in their entirety.

The remote radio socket can include remote repeater/radio electronics to facilitate a common interface between the active electronics and the structured cabling system. The remote radio socket facilitates plugging in the remote radio electronics which convert the optical RF to electrical signals and further distributes this to the distributed antennas 680 for radiation of the analog RF electrical signal for the in building wireless distribution system.

The distributed antennas 680 can be connected to the remote radio socket 660 by a short length of coaxial fiber 685.

Optical drop fibers can be carried from the point of entry box 650 to an anchor point, such as wall receptacle 675 or a piece of communication equipment 670, via low profile duct 655. In a preferred aspect, the duct 655 can be disposed along a wall, ceiling, under carpet, floor, or interior corner of the living unit in an unobtrusive manner, such that the aesthetics of the living unit are minimally impacted. Exemplary low profile ducts are described in U.S. Patent Publications Nos. 2011-0030832 and 2010-0243096, incorporated by reference herein in their entirety.

In one exemplary aspect, the cabling structure can include a first RF signal carrying cable disposed in a first cable track to carry an RF signal from a first wireless service provider and a second RF signal carrying cable disposed in a second cable track to carry an RF signal from a second wireless service provider.

The cabling system described above can be used with RoF DAS and split radio, software defined radio, pico cell, and femto cell in-building wireless networks. In particular, the cabling system can use the inventive cabling structure in a distributed antenna system that can be mounted to a vertical mounting surface such as a wall or a horizontal mounting surface such as a ceiling via the optional adhesive backing layer or can be installed above the ceiling without the additional adhesive backing layer. In an exemplary installation, the cabling structure can be mounted to the wall of the building just below the ceiling.

In one exemplary use, the cabling structure described herein can be used as part of a passive copper coax distribution architecture. In this architecture, some of the cable tracks of the cabling structure can be filled with coax cables (e.g. standard coax cables, micro-coax cables or twinax coax cables) with only a head-end active component. The cabling structure will provide the communication conduit between the active head end component and the antennas distributed throughout the building. Thus, this system can be implemented to connect the discrete distributed antennas to the horizontal coax channels with conventional splitters, taps, and/or couplers. In this manner, multiple service carriers can utilize the adhesive-backed cabling structure as horizontal cabling. This type of architecture can work with many different RF protocols (e.g., any cellular service, iDEN, Ev-DO, GSM, UMTS, CDMA, and others).

In one alternative aspect, the exemplary cabling structure can include multiple coax cables. For example, separate coax conductors can connect to separate antennas of a multiple-input and multiple-output (MIMO) antenna system, e.g., a 2×2 MIMO antenna system, a 4×4 MIMO antenna system, etc. In another alternative aspect, first and second coax conductors can be coupled to a single antenna system with cross-polarized antenna elements.

In another example, the exemplary cabling structure described herein can be used as part of an active analog distribution architecture. In this type of architecture, RF signal distribution can be made over coax or fiber (RoF). In this architecture, the cabling structure can be combined with selected active components, where the types of active components (e.g., O/E converters for RoF, MMIC amplifiers) are selected based on the specific architecture type. This type of architecture can provide for longer propagation distances within the building and can work with many different RF protocols (e.g., any cellular service, iDEN, Ev-DO, GSM, UMTS, CDMA, and others).

The exemplary cabling structure described above can be used in buildings where there are a lack of established horizontal pathways from main distribution boxes to distributed antennas or end user dwellings. For buildings with drywall ceilings and few or no access panels, the adhesive-backed cabling structure of the present invention can be installed without having to enter the existing drywall ceiling by attaching it to a wall or ceiling in an inconspicuous manner. For installations in older buildings in which the blueprints are missing or inaccurate, the adhesive-backed cabling structure can be installed on the basis of a visual survey. Additionally, the adhesive-backed cabling structure, described herein, can minimize or eliminate the need to disturb existing elaborate trim and hallway decorum. In addition, the need to establish major construction areas can be avoided.

The adhesive-backed cabling structure can provide for routing signals to different locations within a building, such as “lunch room,” “conference room,” “meeting room”, etc. The mix and match cable options allows for a separate channel or signal pathways to be set up independent of the other channels, if needed. This type of configuration can provide enhanced signal transmission to key locations within the building without affecting other channels.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. A re-enterable cabling structure, comprising:
a continuous flexible longitudinal body having a planar base portion, a cover portion, and an intermediate portion disposed between the base portion and the cover portion, wherein the intermediate portion is connected to the base portion by the first flexible portion and the cover portion is attached to the intermediate portion by a second flexible portion such that when the cabling structure is folded, the intermediate portion is disposed between the base portion and the cover portion, wherein the base portion includes one or more open cable tracks formed in the base portion.

2. The cabling structure of claim 1, further comprising an adhesive backing layer attached to a portion of the longitudinal body to mount the cabling structure to a mounting surface.

3. The cabling structure of claim 1, further comprising a second grouping of cable tracks formed in the cover portion.

4. The cabling structure of claim 1, further comprising a third grouping of cable tracks in the intermediate portion.

5. The cabling structure of claim 1, further comprising a first securing mechanism to secure the base portion and the intermediate portion to one another when the intermediate portion is folded over the base portion, and a second securing mechanism to secure the intermediate portion and the cover portion to one another when the cover portion is folded over the intermediate portion.

6. The cabling structure of claim 1, wherein the first grouping of cable tracks may be sized to accommodate one of a copper ribbon cable, a fiber ribbon cable a twin ax cable, a twisted pair cable, a microcoax cable, a coated wire, an optical fiber drop cable or a 900 micron coated optical fiber.

7. The cabling structure of claim 3, wherein the second grouping of cable tracks may be sized to accommodate one of a copper ribbon cable, a fiber ribbon cable a twin ax cable, a twisted pair cable, a microcoax cable, a coated wire, an optical fiber drop cable or a 900 micron coated optical fiber.

8. The cabling structure of claim 1, wherein two adjacent cable tracks can be sized to accommodate two different sized communication cables.

9. The cabling structure of claim 1, wherein the one or more cable tracks in the base portion of the longitudinal body can accommodate a first type of telecommunication cable and the second grouping of cable tracks in the cover can accommodate a second type of telecommunication cable.

10. The cabling structure of claim 1, wherein the cable tracks have a C-shaped cross section.

11. The system of claim 1, wherein the duct is flexible such that it can be bent around a curved surface.

12. A cabling system for in-building wireless applications, comprising:
a re-enterable cabling structure that includes a continuous flexible longitudinal body having a planar base portion and a cover portion attached to the base portion by a first flexible portion; and a securing mechanism to secure the base portion and the cover portion to one another when the cover portion is folded over the base portion wherein the base portion includes one or more open cable tracks formed in the base portion to distribute signals from an antenna to an interface box.

13. The cabling system of claim 12, wherein the cabling structure includes a first RF signal carrying cable disposed in a first cable track to carry an RF signal from a first wireless service provider and a second RF signal carrying cable disposed in a second cable track to carry an RF signal from a second wireless service provider.

14. The cabling system of claim 12, wherein the cabling structure is mounted above the ceiling in a building.

15. The cabling system of claim 12, wherein the cabling structure further comprises an adhesive backing layer and wherein the cabling structure is adhesively mountable to a building wall at a position just below a ceiling.

16. The cabling system of claim 12, wherein the cabling structure provides horizontal cabling for a hybrid network architecture.

17. The cabling system of claim 12, wherein the cabling structure provides horizontal cabling for a passive network architecture.

18. The cabling system of claim 12, wherein the cabling structure for an active network architecture.

19. The cabling system of claim 12, wherein the cabling structure provides horizontal cabling for a MIMO antenna system.
